(19) United States
(12) Patent Application Publication
(10) Pub. No.: US 2025/0273071 A1
(43) Pub. Date: Aug. 28, 2025

(54) VEHICLE PARKING METHOD AND VEHICLE FINDING METHOD

(71) Applicant: HON HAI PRECISION INDUSTRY CO., LTD., New Taipei (TW)

(72) Inventors: JUNG-HAO YANG, New Taipei (TW); CHIH-TE LU, New Taipei (TW); CHIN-PIN KUO, New Taipei (TW)

(21) Appl. No.: 18/741,813

(22) Filed: Jun. 13, 2024

(30) Foreign Application Priority Data
Feb. 27, 2024 (CN) 202410211807.3

(51) Int. Cl. G08G 1/14; G01C 21/00; G01C 21/34

(52) U.S. Cl. CPC G08G 1/143; G01C 21/3407; G01C 21/3807; G01C 21/3837

(57) ABSTRACT

A vehicle parking method and a vehicle finding method are provided. The vehicle parking method includes generating a real-time area map of an area of a parking lot based on sensing data of the area, the real-time area map dynamically stores area object data and corresponding object status data in the area of the parking lot. When a parking instruction is received and the target vehicle enters the area of the parking lot, a vehicle location of the target vehicle and a parking space location corresponding to a target parking space are determined based on the area object data and the corresponding object status data. Based on the vehicle location, the parking space location and the real-time area map, a parking route is generated, the target vehicle is controlled to drive to the target parking space according to the parking route.

### FIELD

The present application relates to a field of vehicle technology, and in particular, to a vehicle parking method and a vehicle finding method.

### BACKGROUND

As cities develop, a number of vehicles continues to increase, while a number of parking lots and a space of each parking lot is limited. This leads to a problem of parking difficulties, especially in busy commercial districts, hospitals, schools and other places, where parking spaces are often in short supply. In many parking lots, an improper management and an operation of the parking lot can easily lead to overcrowding, a resource waste and an environmental pollution. In addition, for a parking lot with a large space or an underground parking lot, a driver often has a difficulty in finding the vehicle quickly in the parking lot due to many parking spaces and unclear markings. These situations all lead to a waste of time of the driver and affect an experience of parking and finding the vehicle of the driver.

### BRIEF DESCRIPTION OF THE DRAWINGS

In order to describe the technical solutions of the embodiments of the present application more clearly, the drawings needed to be used in the description of the embodiments of the present application will be briefly introduced below. Obviously, the drawings in the following description are only some implementations of the present application. For example, for those of ordinary skill in the art, other drawings can be obtained based on these drawings without exerting any creative effort.

FIG. 1 is a diagram of an application scenario of a vehicle parking method or a vehicle finding method provided by an embodiment of the present application.

FIG. 2 is a flow chart of an implementation of the vehicle parking method provided by an embodiment of the present application.

FIG. 3 is a flow chart of an implementation of the vehicle finding method provided by an embodiment of the present application.

FIG. 4 is an implementation of a vehicle parking device provided by an embodiment of the present application.

FIG. 5 is an implementation of a vehicle finding device provided by an embodiment of the present application.

FIG. 6 is a schematic structural diagram of a computer device provided by an embodiment of the present application.

FIG. 7 illustrates a schematic diagram of a parking lot including a plurality of parking spaces.

### DETAILED DESCRIPTION

It should be noted that terms “first” and “second” in the description, claims and drawings of the present application are used to distinguish similar objects, rather than describing a specific order or a sequence.

In addition, it should be noted that the method disclosed in the embodiment of the present application or the method shown in the flow chart includes one or more steps for implementing the method. Without departing from a scope of the claims, an order of executing a plurality of steps can be interchanged with each other and some of the steps can also be deleted.

Some embodiments will be described below with reference to the accompanying drawings. The following embodiments and features in the embodiments may be combined with each other without conflict.

The vehicle parking method and the vehicle finding method provided by the embodiments of the present application can be applied to a pre-designed parking lot management system of an area of a parking lot. The parking lot management system can be integrated into a computer device by technical means such as a database integration, an API interface docking, etc., to achieve a unified management and an operation of vehicles, parking spaces in the area of the parking lot.

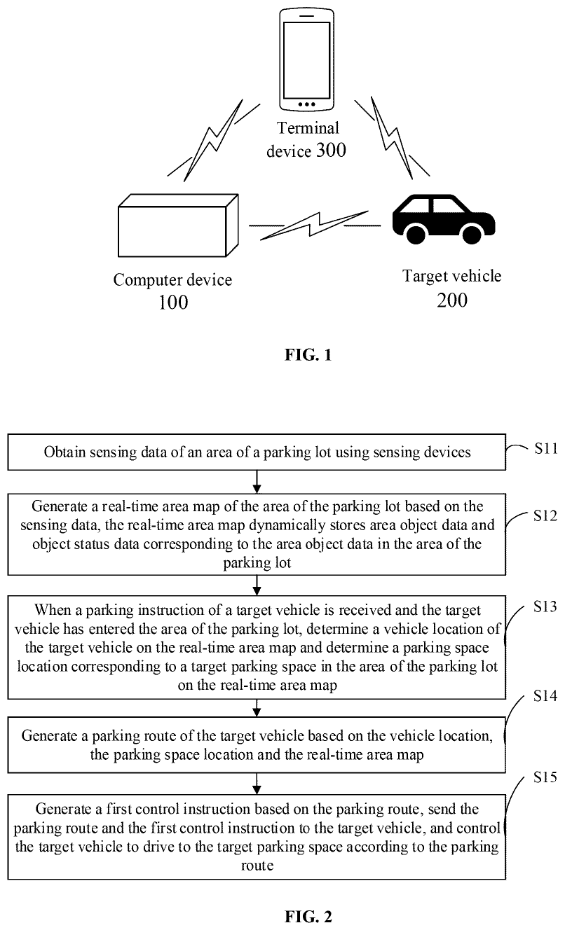

Please refer to FIG. 1, which shows a diagram of an application scenario of a vehicle parking method provided by the embodiment of the present application. As shown in FIG. 1, a computer device 100, a terminal device 300 and a target vehicle 200 are communicatively connected. In some embodiments, the computer device 100 is communicatively connected with sensing devices in an area of the parking lot, and the computer device 100 can control the sensing devices to detect sensing data in the area of the parking lot and obtain the sensing data. The computer device 100 may generate a real-time area map of the area of the parking lot based on the sensing data of the area of the parking lot. Among them, the real-time area map dynamically stores area object data and object status data corresponding to the area object data in the area of the parking lot. The area object data includes but is not limited to, data of drivers, vehicles, and parking spaces. The object status data includes but is not limited to, locations of objects, and correspondences between objects.

In some embodiments, a user can operate and trigger a parking instruction of the target vehicle 200 through the terminal device 300 or the target vehicle 200. The terminal device 300 or the target vehicle 200 sends the parking instruction to the computer device 100. When the computer device 100 receives the parking instruction of the target vehicle 200 and detects that the target vehicle 200 has entered the area of the parking lot, a location (hereinafter “vehicle location”) of the target vehicle 200 on the real-time area map can be determined and a location (hereinafter “parking space location”) of a target parking space in the area of the parking lot on the real-time area map can be determined based on the area object data and the corresponding object status data. The computer device 100 can generate a parking route of the target vehicle 200 based on the vehicle location, the parking space location, and real-time area map, generate a first control instruction based on the parking route, and send the parking route and the first control instruction to the target vehicle 200 to control the target vehicle 200 to drive to the target parking space according to the parking route.

In some embodiments, the user can operate and trigger a finding instruction of the target vehicle 200 through the terminal device 300 or the target vehicle 200. The terminal device 300 or the target vehicle 200 sends the finding instruction to the computer device 100. When the computer device 100 receives the finding instruction of the target vehicle 200, the computer device 100 obtains the real-time area map of the area of the parking lot and the area object data and the corresponding object status data dynamically stored in the real-time area map. The computer device 100 can determine the parking space location corresponding to the target parking space of the target vehicle 200 and a preset vehicle pickup location based on the finding instruction, the area object data and the corresponding object status data. A route of finding the target vehicle 200 (hereinafter “vehicle finding route of the target vehicle 200”) is generated based on the parking space location, the preset vehicle pickup location and the real-time area map. The computer device 100 generates a second control instruction based on the vehicle finding route, sends the vehicle finding route and the second control instruction to the target vehicle 200 and controls the target vehicle 200 to drive to the preset vehicle pickup location according to the finding route.

In some embodiments, an application program for monitoring, controlling, and managing the target vehicle 200 and providing users with services related to the target vehicle 200 can be installed on the terminal device 300. The application program can establish a communication connection with a parking lot management system through a network, a communication protocol, data exchange, etc. The parking lot management system can provide parking services, vehicle pickup services, reservation services, etc. Through the application program, users can choose parking services, vehicle pickup services, reservation services, etc., and can trigger the parking instruction or the finding instruction to authorize the parking lot management system to take over the target vehicle 200 and control the target vehicle 200 to park or find the target vehicle 200.

In some embodiments, the application program can also be installed on the target vehicle 200, so that the user can trigger the parking instruction or the finding instruction through the target vehicle 200.

In some embodiments, the communication connection include, but is not limited to, a wired connection and a wireless connection. The computer device 100 can be a computer, an independent server or a server cluster composed of multiple servers. The terminal device 300 includes but is not limited to one or more devices such as mobile phones, tablet computers, and wearable devices.

Please refer to FIG. 2, which is an implementation of a flow chart of a vehicle parking method provided by an embodiment of the present application. The method is applied to the computer device 100 shown in FIG. 1 and includes following steps.

S11, the computer device obtains sensing data of an area of a parking lot using sensing devices.

In some embodiments, the computer device is communicatively connected to the sensing devices. The sensing devices collect the sensing data of the area of the parking lot and can transmit the sensing data of the area of the parking lot to the computer device through a communication link with the computer device.

In some embodiments, the sensing devices include but are not limited to cameras, millimeter wave radars, optical radars, and ultrasonic sensors. In order to fully cover and collect sensing data in the area of the parking lot, the embodiment of the present application designs and deploys the sensing devices required for the real-time area map based on a structure and a scope of the area of the parking lot. These sensing devices are distributed in every corner of the area of the parking lot, ensuring monitoring and data collection of the entire area of the parking lot to capture detailed information within the area of the parking lot.

For example, as shown in FIG. 7, in a parking lot 4 including a plurality of parking spaces 41, there are sensing devices 42 are distributed in corners of an area of the parking lot 4.

S12, the computer device generates a real-time area map of the area of the parking lot based on the sensing data. The real-time area map dynamically stores area object data and object status data corresponding to the area object data in the area of the parking lot.

In some embodiments, the real-time area map may be a topological map, a semantic map, etc. The area object data at least includes data of drivers, vehicles and parking spaces. The object status data at least includes locations of objects and correspondences between the objects, for example, the area object data may include a location of a vehicle, a location of a parking space, and a correspondence between the parking space and the vehicle, etc. Since statuses of objects such as vehicles, drivers, and parking spaces in the area of the parking lot changes dynamically, in order to maintain an accuracy and a real-time nature of the real-time area map, it is necessary to regularly update map data stored in the real-time area map, so that real-time area map dynamically stores the area object data and the corresponding object status data in the area of the parking lot.

In some embodiments, the computer device can continuously collect sensing data using the sensing devices and repeat the above steps S11-S12 to implement real-time updating of the real-time area map, thereby updating the area object data and the corresponding object status data in the area of the parking lot stored in the real-time area map.

In some embodiments, objects in the area of the parking lot and statuses of the objects may be displayed in the real-time area map.

In some embodiments, in a process of generating the real-time area map of the area of the parking lot based on the sensing data, the computer device can use a vision-based map construction method, and use a computer vision technology, such as a feature extraction, a simultaneous localization and mapping (SLAM) technology, etc., to generate the real-time area map of the area of the parking lot based on the sensing data; or use a neural network model to generate the real-time area map of the area of the parking lot based on the sensing data. The embodiments of the present application do not limit the method of constructing the real-time area map.

In some embodiments of the present application, generating the real-time area map of the area of the parking lot based on the sensing data includes obtaining preprocessed sensing data by preprocessing the sensing data; and generating the real-time area map by analyzing the preprocessed sensing data using a preset map construction model.

In some embodiments, preprocessing the sensing data includes but is not limited to align time of the sensing data so that the sensing data of different times can be matched; determine a correspondence between the sensing data, and perform a noise filtering on the sensing data. The computer device preprocesses the sensing data, and generates the real-time area map based on the preprocessed sensing data using the preset map construction model, which is beneficial to ensuring the accuracy and reliability of the map data.

In some embodiments, the preset map construction model may be a deep learning network model, such as a convolutional neural network model, a recurrent neural network model, a generative adversarial network model, a hybrid model, etc. In the process of using the preset map construction model to analyze the preprocessed sensing data and generate the real-time area map, the computer device can fuse the sensing data from different sensing devices to obtain a more comprehensive and accurate environment. Perceive information. For example, the computer device can use fusion algorithms such as a weighted averaging and a Kalman filtering to fuse the sensing data from different sensing devices into a unified data stream. Then, the computer device can extract useful features from the fused data, such as spatial features, texture features, etc., and use these features as an input of the preset map construction model. The preset map construction model processes and analyzes the input feature data to generate the real-time area map of the area of the parking lot.

In some embodiments, the computer device can perform a post-processing and visualization operations, such as a smoothing processing, a color rendering, etc., on the real-time area map generated using the preset map construction model to obtain a real-time area map that is more intuitive and easy-to-understand.

In some embodiments of the present application, before generating the real-time area map based on the preprocessed sensing data using the preset map construction model, the method further includes obtaining a training sample set, which includes multiple sets of data samples collected by different sensing devices; and obtaining the preset map construction model by training an initial map construction model using the training sample set.

In some embodiments, the training sample set includes multiple sets of data samples collected by different sensing devices. In a process of training the initial map construction model using the training sample set, the computer device can perform a data preprocessing, a data fusion and a feature extraction on the training sample set to obtain sample features, and use the sample features as an input of the initial map construction model for training the initial map construction model. During the training process, parameters of the initial map construction model are adjusted to improve an accuracy and a generalization ability of the model. Further, the computer device can use appropriate evaluation indicators and methods, such as calculating an accuracy, a recall rate, etc. of the model, to evaluate and optimize the trained map construction model to determine its performance and accuracy.

In some embodiments, the initial map construction model includes, but is not limited to, a convolutional neural network model, a recurrent neural network model, and the like.

S13, when the computer device receives the parking instruction of a target vehicle and detects that the target vehicle has entered the area of the parking lot, the computer device determines the vehicle location of the target vehicle on the real-time area map and determines the parking space location corresponding to a target parking space in the area of the parking lot on the real-time area map.

In some embodiments, an application program for controlling and managing the target vehicle is installed in the terminal device or the target vehicle. The application program is bound to the parking lot management system and can provide users with parking services, vehicle finding services, reservation services, queue services. A user can trigger the parking instruction of the target vehicle and request the parking service through the application program in the terminal device or in the target vehicle. The terminal device or the target vehicle responds to the user's operation and can send the parking instruction to a computer device corresponding to the parking lot management system. The computer device responds to the parking instruction of the target vehicle. When the computer device detects that the target vehicle has entered the area of the parking lot, the computer device obtains the area object data and the corresponding object status data in the area of a current parking lot based on a current real-time area map, and based on the area object data and the corresponding object status data to determine the vehicle location of the target vehicle in the real-time area map and the parking space location corresponding to the target parking space in the area of the parking lot on the real-time area map (that is, the parking space location on the real-time area map corresponds to the target parking space in the area of the parking lot).

In some embodiments, the target parking space includes a vacant parking space within the current area of the parking lot.

In some embodiments, the parking instruction includes, but is not limited to, a vehicle takeover instruction or a vehicle authorization instruction. The computer device can only control the target vehicle in condition that the user authorizes the computer device to take over the target vehicle.

In some embodiments, the user can reserve parking in the area of the parking lot through the application program corresponding to the target vehicle. When the computer device receives parking service requests from a plurality of vehicles, the computer device can queue up the plurality of vehicles according to a preset queuing strategy, for example, according to an order of a time of each of the parking service requests is received. After the vehicles enter the area of the parking lot, the vehicles are queued in sequence. The computer device takes over each vehicle, determines the parking space for each vehicle, and controls each vehicle to drive to the corresponding parking space.

In some embodiments, the user can obtain the real-time area map of the area of the parking lot through the terminal device or the target vehicle. The real-time area map can display objects in the area of the parking lot and the status of each object. For example, one parking space is displayed in the real-time area map, and the parking space is idle. The user can select the target parking space for the target vehicle based on the real-time area map of the area of the parking lot. The terminal device may send information including the target parking space to the computer device in response to the user's selection operation. The computer device can obtain the corresponding parking space location according to the target parking space selected by the user.

In some embodiments of the present application, the computer device determines the parking space location corresponding to the target parking space in the area of the parking lot on the real-time area map, including: determining parking space status data of all parking spaces in the area of the parking lot based on the area object data and the corresponding object status data; determining a usage status of each of all parking spaces based on the parking space status data; determining all idle parking spaces in the area of the parking lot based on the usage status of each parking space; determining the target parking space from the all idle parking spaces according to a preset strategy; determining the parking space location corresponding to the target parking space on the real-time area map based on the parking space status data.

In some embodiments, the area object data includes data of objects such as vehicles, parking spaces, drivers, and other objects. The object status data includes but is not limited to the locations of objects such as vehicles, parking spaces, drivers and other objects, the usage status of each parking space, and the correspondence between the vehicles and the parking spaces, etc. The preset strategy may include, for example, a distance priority strategy, a path priority strategy, etc.

In some embodiments, in the process of determining the parking space location corresponding to the target parking space in the area of the parking lot on the real-time area map, the computer device can obtain the current real-time area map of the area of the parking lot and obtain the current area object data and the corresponding object status data based on the real-time area map. According to the area object data and the corresponding object status data of the area of the parking lot, the parking space status data of all parking spaces in the area of the parking lot can be determined. According to the parking space status data of all parking spaces, the usage status of each parking space can be determined, such as there is a vehicle parked in the parking space, the parking space is idle, or the parking space is reserved, etc. The computer device can determine all of the idle parking spaces in the area of the parking lot according to the usage status of each parking space, that is, the parking spaces in the idle state. According to the preset strategy, the computer device can determine the target parking space from all idle parking spaces, according to the distance priority strategy, determine an idle parking space closest to the vehicle location of the target vehicle from all idle parking spaces as the target parking space, or, for example, determine an idle parking space with a shortest path to the vehicle location of the target vehicle as the target parking space according to the path priority strategy. After determining the target parking space, the computer device can obtain the parking space status data corresponding to the target parking space, and can determine the parking space location corresponding to the target parking space on the real-time area map based on the parking space status data corresponding to the target parking space.

S14, the computer device generates the parking route of the target vehicle based on the vehicle location, the parking space location and the real-time area map.

In some embodiments, the computer device can use a neural network model to process and analyze the vehicle location of the target vehicle, the parking space location, and the real-time area map, and can output the parking route of the target vehicle. The parking route can be composed of a list of waypoints. The neural network model may be, for example, a convolutional neural network model, a recurrent neural network model, a generative adversarial network model, etc.

In other embodiments, the computer device can also use some path planning algorithms, such as a genetic algorithm, to plan the parking route of the target vehicle based on the vehicle location, the parking space location and the real-time area map, or invoke an interface of a public map application to use a function of planning a route of the map application to plan the parking route of the target vehicle. The present application does not limit the method of generating the parking route of the target vehicle.

In some embodiments of the present application, generating the parking route for the target vehicle based on the vehicle location, the parking space location, and the real-time area map includes: outputting the parking route of the target vehicle using a preset route planning model based on the vehicle location, the parking space location, and the real-time area map.

In some embodiments, the preset route planning model may be a neural network model, such as a convolutional neural network model, a recurrent neural network model, etc.

In the process of outputting the parking route of the target vehicle using the preset route planning model based on the vehicle location, the parking space location, and the real-time area map, the computer device can pre-process the vehicle location, the parking space location and the real-time area map, such as obtaining the vehicle location, standardized coordinates of parking space locations on real-time area maps, converting the real-time area map into a processable format, etc. The computer device uses the preset route planning model to process and analyze the preprocessed vehicle location, the preprocessed parking space location and the preprocessed real-time area map, and can output a predicted parking route of the target vehicle.

In some embodiments of the present application, before the preset route planning model is used to analyze the vehicle location, the parking space location and the real-time area map, and output the parking route of the target vehicle, the method further includes: obtaining model training samples, which includes multiple sets of data, each set of data of the multiple sets of data includes an initial location of a vehicle, a destination location of the vehicle, and a real-time regional map, the multiple sets of data being different from each other; and using the model training samples to train an initial route planning model to obtain the preset route planning model.

In some embodiments, the computer device may obtain the model training samples and use the model training samples as training samples of a preset route planning model. The computer device selects an appropriate initial route planning model, such as a convolutional neural network model, a recurrent neural network model, etc., to ensure that the model can receive the initial location of the vehicle, the destination location of the vehicle, and the real-time area map as an input, and output a trajectory route. Then the computer device can use the model training samples to train the initial route planning model, and can optimize model parameters by minimizing a loss function, so that the initial route planning model can output a more accurate and reasonable trajectory route. The computer device can divide the obtained model training samples into training samples and verification samples, use the training samples to train the initial route planning model, use the verification samples to evaluate a performance of the model, and adjust a network structure or hyperparameters as needed to improve an accuracy and a robustness of the model, and finally obtain the trained initial route planning model as the preset route planning model.

S15, the electronic device generates a first control instruction based on the parking route, sends the parking route and the first control instruction to the target vehicle, and controls the target vehicle to drive to the target parking space according to the parking route.

In some embodiments, the computer device may utilize a model predictive control method to convert the parking route into the first control instruction. The first control instruction may include a control of an acceleration, a speed, a steering wheel, a vehicle orientation, etc.

In some embodiments, a vehicle control module is installed in the target vehicle. The vehicle control module can be implemented in whole or in part by software, hardware, and combinations thereof. The vehicle control module is used to receive the parking route and the first control instruction sent by the computer device, and to read a vehicle status of the target vehicle, and can return the vehicle status of the target vehicle to the computer device. The target vehicle responds to the first control instruction and can control the target vehicle to drive to the target parking space according to the parking route.

In some embodiments of the present application, if the electronic device updates the target parking space based on the area object data and the corresponding object status data, the electronic device obtains an updated parking space location corresponding to the updated target parking space and obtains the current location of the target vehicle; and regenerates the parking route of the target vehicle based on the current location, the updated parking space location and the real-time area map.

In some embodiments, when the target vehicle is driving according to the parking route, it may be necessary to temporarily change the location of the target parking space of the target vehicle because the currently determined target parking space is occupied. At this time, the computer device can repeatedly execute steps S11 to S12 to obtain a real-time area map of the area of the parking lot, and obtain real-time area object data and the corresponding object status data of the area of the parking lot based on the real-time area map. The computer device can update the target parking space based on the real-time area object data and the corresponding object status data, re-determine the parking space location corresponding to the updated target parking space, and obtain the current location of the target vehicle. The computer device can regenerate the parking route of the target vehicle based on the current location of the target vehicle, the updated parking space location and the real-time area map, generate an updated first control instruction based on the updated parking route, and send the updated parking route and the updated first control instruction to the target vehicle to control the target vehicle to drive to the updated target parking space according to the updated parking route.

In some embodiments of the present application, after controlling the target vehicle to drive to the target parking space according to the parking route, the computer device further updates the area object data and the corresponding object status data in the area of the parking lot based on the correspondence between the target vehicle and the target parking space.

In some embodiments, after controlling the target vehicle to drive to the target parking space according to the parking route, the computer device establishes a corresponding relationship between the target vehicle and the target parking space, and updates the area object data and the corresponding object status data in the area of the parking lot according to the corresponding relationship between the target vehicle and the target parking space, such as updating the vehicle status data of the target vehicle and updating the usage status of the target parking space, etc.

The vehicle parking method provided by the embodiment of the present application obtains the sensing data of the area of the parking lot using the sensing devices of the area of the parking lot, generates a real-time area map of the area of the parking lot based on the sensing data. Among them, the real-time area map dynamically stores the area object data and the corresponding object status data in the area of the parking lot. The area object data includes but is not limited to data of drivers, vehicles, and parking spaces. The object status data includes but is not limited to locations of objects, correspondence between the objects. When the parking instruction of the target vehicle is received and the target vehicle is detected to drive into the area of the parking lot, the location of the target vehicle in the real-time area map and the parking space location corresponding to the target parking space in the area of the parking lot on the real-time area map can be determined based on the area object data and the corresponding object status data in the real-time area map. Based on the vehicle location, the parking space location and the real-time area map, the parking route of the target vehicle can be generated, the first control instruction is generated based on the parking route, the parking route and the first control instruction are sent to the target vehicle, and the target vehicle is controlled to drive to the target parking space according to the parking route. When the target vehicle enters the area of the parking lot, the computer device corresponding to the parking lot management system takes over the target vehicle, determines the target parking space and controls the target vehicle to drive to the target parking space, which can reduce the waste of users or drivers when looking for parking spaces. It saves valuable time and resources to improve the driver's parking experience and can more effectively utilize a limited area of the parking lot, improve a utilization rate of the area of the parking lot, and create greater usage benefits.

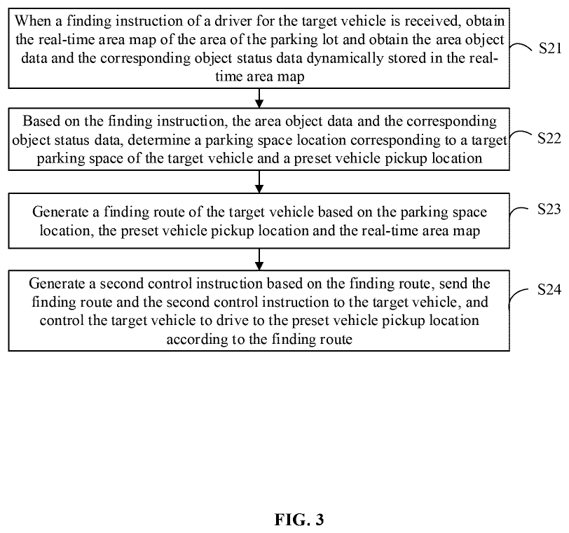

Please refer to FIG. 3, FIG. 3 shows an implementation of a flow chart of a vehicle finding method provided by the embodiment of the present application. The method is applied to a computer device such as the computer device 100 shown in FIG. 1. The method includes the following steps.

S21, when the computer device receives a finding instruction of a driver for the target vehicle, the computer device obtains the real-time area map of the area of the parking lot and obtains the area object data and the corresponding object status data dynamically stored in the real-time area map.

In some embodiments, a current real-time area map of the area of the parking lot may be generated based on steps S11 to S12. The real-time area map dynamically stores the area object data and the corresponding object status data.

In some embodiments, an application program for controlling and managing the target vehicle is installed in the terminal device or the target vehicle. The application program is bound to the parking lot management system and can provide users with parking services, vehicle finding services, reservation services, queue services. The user can trigger the finding instruction of the target vehicle and request the vehicle finding service through the application program in the terminal device or in the target vehicle. The terminal device or the target vehicle responds to the user's operation and can send the finding instruction to the computer device corresponding to the parking lot management system. The computer device responds to the finding instruction of the target vehicle and obtains the real-time area map of the area of the parking lot and the area object data and the corresponding object status data dynamically stored in the real-time area map.

S22, based on the finding instruction, the area object data and the corresponding object status data, the computer device determines a parking space location corresponding to the target parking space of the target vehicle and a preset vehicle pickup location.

In some embodiments, the finding instruction may include vehicle information of the target vehicle, such as a license plate number, a vehicle identification, and other information, as well as information such as a preset pickup location. The area object data may include identifiers of objects such as vehicles, parking spaces, drivers and other objects, and the object status data may include locations of objects such as the vehicles, the parking spaces, the drivers and other objects, as well as the correspondence between the objects. Thereby, the computer device determines the parking space location corresponding to the target parking space of the target vehicle and the preset vehicle pickup location based on the finding instruction, the area object data and the corresponding object status data.

In some embodiments of the present application, determining the parking space location corresponding to the target parking space of the target vehicle and the preset vehicle pickup location based on the finding instruction, the area object data and the corresponding object status data includes: parsing the finding instruction, and obtaining a preset pickup location (hereinafter referred to “preset actual vehicle pickup location”) which is located in the area of the parking lot; determining the preset vehicle pickup location corresponding to the preset actual vehicle pickup location on the real-time area map based on the area object data and the corresponding object status data; determining the target vehicle and a status of the target vehicle based on the area object data and the corresponding object status data; determining the target parking space of the target vehicle, the parking space location corresponding to the target parking space on the real-time area map based on the target vehicle and the status of the target vehicle.

In some embodiments, the user can set a location in the area of the parking lot as the preset actual vehicle pickup location through the application program corresponding to the target vehicle. Based on the user's operation, the terminal device or the target vehicle where the application program is located can generate the finding instruction based on the preset actual vehicle pickup location, and send the finding instruction to the computer device. The computer device parses the finding instruction, and obtains the preset actual vehicle pickup location, and determines the preset vehicle pickup location in the real-time area map based on the area object data and the corresponding object status data.

In some embodiments, the computer device parses the finding instruction and obtains vehicle information such as the vehicle identification of the target vehicle, and determines the target vehicle based on the vehicle identification. Further, according to the area object data and the corresponding object status data in the real-time area map, the target vehicle and the status of the target vehicle can be determined. According to the target vehicle and the status of the target vehicle, the target parking space of the target vehicle and the parking space location corresponding to the target parking space on the real-time area map can be determined.

In some embodiments, the computer device can pre-set the actual vehicle pickup location, and the driver can go to the actual vehicle pickup location and wait to pick up the vehicle.

S23, the electronic device generates a finding route of the target vehicle based on the parking space location, the preset vehicle pickup location and the real-time area map.

In some embodiments, the computer device can use a neural network model to process and analyze the parking space location of the target vehicle, the preset vehicle pickup location, and the real-time area map, and output the finding route of the target vehicle. The finding route can be composed of a list of waypoints. The neural network model may be, for example, a convolutional neural network model, a recurrent neural network model, a generative adversarial network model, etc.

In other embodiments, the computer device can also use some path planning algorithms, such as genetic algorithms, to plan the finding route of the target vehicle based on the parking space location, the preset vehicle pickup location and the real-time area map, or invoke an interface of a public map application to use a function of planning a route of the map application to plan the finding route of the target vehicle. The present application does not limit the method of generating the finding route of the target vehicle.

In some embodiments of the present application, generating the finding route of the target vehicle based on the parking space location, the preset vehicle pickup location and the real-time area map includes: outputting the finding route of the target vehicle by a preset route planning model based on the parking space location, the preset vehicle pickup location and the real-time area map.

In some embodiments, the preset route planning model may be a neural network model, such as a convolutional neural network model, a recurrent neural network model, etc.

In the process of using the preset route planning model to output the finding route of the target vehicle based on the parking space location, the preset vehicle pickup location and the real-time area map, the computer device can preprocess the parking space location, the preset vehicle pickup location and the real-time area map, such as obtaining the standardized coordinates of the preset vehicle pickup location and the standardized coordinates of the parking space location in the real-time area map, converting the real-time area map into a processable format, etc. The computer device uses the preset route planning model to process and analyze the preprocessed parking space location, the preprocessed preset vehicle pickup location and the preprocessed real-time area map, and can output the finding route of the target vehicle that has been predicted.

In some embodiments, an implementation method of generating the finding route of the target vehicle based on the parking space location, the preset vehicle pickup location and the real-time area map can refer to the implementation method of generating the parking route of the target vehicle based on the vehicle location, the parking space location and the real-time area map in step S14.

S24, the computer device generates a second control instruction based on the finding route, sends the finding route and the second control instruction to the target vehicle, and controls the target vehicle to drive to the preset vehicle pickup location according to the finding route.

In some embodiments, the computer device may use a model predictive control method to convert the finding route into the second control instruction. The second control instruction may include a control of an acceleration, a speed, a steering wheel, a vehicle orientation of the target vehicle.

In some embodiments, a vehicle control module is installed in the target vehicle. The vehicle control module is configured to receive the finding route and the second control instruction sent by the computer device, determine the vehicle status of the target vehicle, and can return the vehicle status of the target vehicle to the computer device. The target vehicle responds to the second control instruction and can control the target vehicle to drive to the preset vehicle pickup location according to the finding route.

In some embodiments of the present application, if the computer device determines that the preset vehicle pickup location has changed based on the area object data and the corresponding object status data, the computer device obtains an updated vehicle pickup location and a current location of the target vehicle; and regenerates the finding route of the target vehicle based on the current location, the updated vehicle pickup location, and the real-time area map.

In some embodiments, as the target vehicle is traveling according to the finding route, the preset actual vehicle pickup location may change. At this time, the computer device can reacquire the real-time area map of the area of the parking lot, and obtain the real-time object data and the corresponding object status data of the area of the parking lot based on the real-time area map area. Based on the real-time area object data and the corresponding object status data, an updated vehicle pickup location can be determined and the current location of the target vehicle can be obtained. The computer device can regenerate the finding route of the target vehicle based on the current location of the target vehicle, the updated vehicle pickup location and the real-time area map, generate an updated second control instruction based on the updated finding route, and convert the updated finding route to the finding route of the target vehicle, send the finding route and the second control instruction to the target vehicle, and control the target vehicle to drive to the updated vehicle pickup location according to the updated finding route.

In some embodiments of the present application, after controlling the target vehicle to drive to the preset vehicle pickup location according to the finding route, the computer device can update the area object data and the corresponding object status data in the area of the parking lot, such as updating the usage status of the target parking space, etc.

The vehicle finding method provided by the embodiment of the present application obtains the real-time area map of the area of the parking lot and the area object data and the corresponding object status data dynamically stored in the real-time area map when the finding instruction of the target vehicle is received. Based on the finding instruction, the area object data and the corresponding object status data, the parking space location and the preset vehicle pickup location corresponding to the target parking space of the target vehicle can be determined. Based on the parking space location, the preset vehicle pickup location and the real-time area map, the finding route of the target vehicle is generated, the second control instruction is generated based on the finding route, and the finding route and the second control instruction can be sent to the target vehicle to control the target vehicle to drive to the preset vehicle pickup location according to the finding route. When the user or the driver needs to pick up a vehicle from the area of the parking lot, the only needs to trigger a instruction for finding the vehicle. The parking lot management system responds to the instruction to take over the target vehicle and controls the target vehicle to drive to the preset vehicle pickup location, which can reduce the time of the user or the driver when finding for the parking space of the vehicle, which improves the driver's vehicle finding experience.

It should be understood that a sequence number of each step in the above embodiment does not mean an execution order. The execution order of each step should be determined by its function and internal logic, and should not constitute any limitation on the implementation process of the embodiment of the present application.

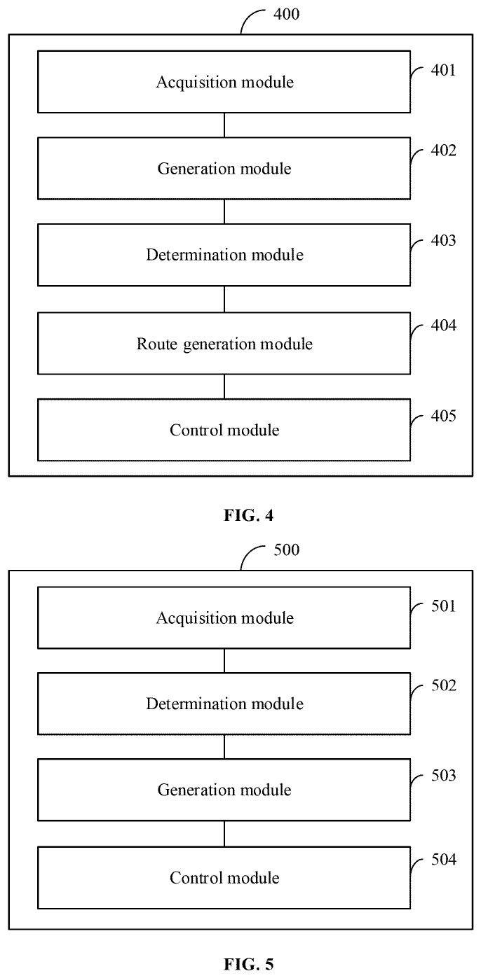

In one embodiment of the present application, a vehicle parking device 400 is provided, which is applied to a computer device. The functions that the vehicle parking device 400 can implement correspond to the vehicle parking method in the above embodiment. As shown in FIG. 4, the vehicle parking device 400 includes an acquisition module 401, a map generation module 402, a determination module 403, a route generation module 404 and a control module 405. The detailed description of each functional module is as follows: the acquisition module 401 is used to obtain the sensing data of the area of the parking lot using sensing devices; the map generation module 402 is used to generate a real-time area map of the area of the parking lot based on the sensing data. The real-time area map dynamically stores area object data and the corresponding object status data in the area of the parking lot. The area object data at least includes data about drivers, vehicles and parking spaces. The object status data at least includes locations of objects and correspondence relationships between the objects; the determination the module 403 is used to determine the vehicle location of the target vehicle on the real-time area map and determines the parking space location corresponding to a target parking space in the area of the parking lot on the real-time area map based on the area object data and the corresponding object status data when receiving the parking instruction of the target vehicle and detecting that the target vehicle has entered the area of the parking lot; the route generation module 404 is used to generate the parking route of the target vehicle based on the vehicle location, the parking space location and the real-time area map; the control module 405 is used to generate a first control instruction based on the parking route, send the parking route and the first control instruction to the target vehicle, and control the target vehicle to drive to the target parking space according to the parking route.

For specific limitations on the vehicle parking device 400, please refer to the above limitations on the vehicle parking method, which will not be described again here. Each module in the vehicle parking device 400 can be implemented in whole or in part by software, hardware, and combinations thereof. Each of the modules may be embedded in or independent of the processor of the computer device in the form of hardware, or may be stored in the storage device of the computer device in the form of software, so that the processor can invoke and execute the operations corresponding to the above modules.

In one embodiment of the present application, a vehicle finding device 500 is provided, which is applied to the computer device. The functions that the vehicle finding device 500 can implement correspond to the vehicle finding method in the above embodiment. As shown in FIG. 5, the vehicle finding device 500 includes an acquisition module 501, a determination module 502, a generation module 503 and a control module 504. The detailed description of each functional module is as follows: the acquisition module 501 is used to obtain the real-time area map of the area of the parking lot and the area object data and the corresponding object status data dynamically stored in the real-time area map when receiving the finding instruction of the driver for the target vehicle; the determination module 502 is used to determine the parking space location and the preset vehicle pickup location corresponding to the target parking space of the target vehicle based on the finding instruction, the area object data and the corresponding object status data; the generation module 503 is used to generate the finding route of the target vehicle based on the parking space location, the preset vehicle pickup location and the real-time area map; the control module 504 is used to generate a second control instruction based on the finding route, and send the finding route and the second finding route to the target vehicle to control the target vehicle to drive to the preset vehicle pickup location according to the finding route.

For specific limitations on the vehicle finding device 500, please refer to the above limitations on the vehicle finding method, which will not be described again here. Each module in the vehicle finding device 500 can be implemented in whole or in part by software, hardware, and combinations thereof. Each of the above modules may be embedded in or independent of the processor of the computer device in the form of hardware, or may be stored in the memory of the computer device in the form of software, so that the processor can call and execute the operations corresponding to the above modules.

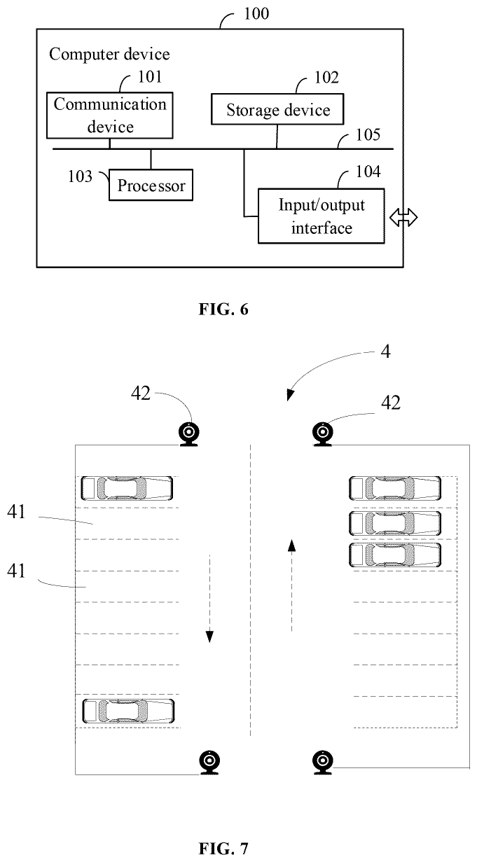

Please refer to FIG. 6, which is a schematic structural diagram of a computer device provided by an embodiment of the present application. A network where the computer device 100 is located includes but is not limited to the Internet, a wide area network, a metropolitan area network, a local area network, a virtual private network (VPN), etc.

As shown in FIG. 6, the computer device 100 includes a communication device 101, a storage device 102, a processor 103, an input/output (I/O) interface 104 and a bus 105. The processor 103 is coupled to the communication device 101, the storage device 102, and the input/output interface 104 through the bus 105, respectively.

The communication device 101 may be a wireless communication device or a mobile communication device. The wireless communication device may provide wireless communication solutions applied to the computer device 100 including a wireless local area networks (WLAN) (for example, wireless fidelity (Wi-Fi) network), a Bluetooth (BT), and a global navigation satellite system (GNSS), a frequency modulation (FM), a near field communication (NFC), an Infrared (IR) and other wireless communication solutions. The mobile communication device can provide wireless communication solutions including 2G/3G/4G/5G applied to the computer device 100.

The storage device 102 may include one or more random access memories (RAM) and one or more non-volatile memories (NVM). The random access memory can be directly read and written by the processor 103, can be used to store executable programs (such as machine instructions) of the operating system or other running programs, and can also be used to store user data and application data, etc. The random access memory can include a static random-access memory (SRAM), a dynamic random-access memory (DRAM), a synchronous dynamic random-access memory (SDRAM), a double data Rate Synchronous Dynamic Random-access memory (DDR SDRAM, for example, the fifth generation DDR SDRAM is generally called DDR5 SDRAM), etc.

The non-volatile memory can also store executable programs and user data and application data, etc., and can be loaded into the random access memory in advance for direct reading and writing by the processor 103. The non-volatile memory can include a disk storage device and a flash memory.

The storage device 102 is used to store one or more computer programs. The one or more computer programs are configured for execution by processor 103. The one or more computer programs include a plurality of instructions. When the plurality of instructions are executed by the processor 103, the vehicle parking method or the vehicle finding method executed on the computer device 100 can be implemented.

In other embodiments, the computer device 100 further includes an interface for connecting to an external storage device to expand a storage capacity of the computer device 100.

The processor 103 may include one or more processing units. For example, the processor 103 may include an application processor (AP), a modem processor, a graphics processing unit (GPU), and an image signal processor (ISP), a controller, a video codec, a digital signal processor (DSP), a baseband processor, and/or neural-network processing unit (NPU), etc. Among them, different processing units can be independent devices or the different processing units can be integrated in one or more processors.

The processor 103 provides a computing capability and a control capability. For example, the processor 103 is used to execute a computer program stored in the storage device 102 to implement the vehicle parking method or the vehicle finding method.

The I/O interface 104 is used to provide a channel for user input or output. For example, the I/O interface 104 can be used to connect various input and output devices, such as a mouse, a keyboard, a touch device, a display screen, etc., so that the user can input information. Or information can be visualized.

The bus 105 is at least used to provide a channel for a mutual communication among the communication device 101, the storage device 102, the processor 103, and the I/O interface 104 in the computer device 100.

It can be understood that the structure illustrated in the embodiment of the present application does not constitute a specific limitation on the computer device 100. In other embodiments of the present application, the computer device 100 may include more or fewer components than shown in the figure, or some components may be combined, some components may be separated, or some components may be arranged differently. The components illustrated may be implemented in hardware, software, or a combination of software and hardware.

Embodiments of the present application also provide a computer-readable storage medium. A computer program is stored on the computer-readable storage medium. The computer program includes program instructions. The method implemented when the program instructions are executed may refer to the vehicle parking method or the vehicle finding method in each of the above embodiments.

The computer-readable storage medium may be an internal storage device of the computer device described in the above embodiment, such as a hard disk or a memory of the computer device. The computer-readable storage medium may also be an external storage device of the computer device, such as a plug-in hard disk, a smart memory card (SMC), or a secure digital (SD) card, a flash card equipped on the computer device.

Further, the computer-readable storage medium may mainly include a storage program area and a storage data area, among them, the storage program area may store an operating system, an application program required for at least one function, etc.; the storage data area may store data created according to a use of the computer device.

Finally, it should be noted that the above embodiments are only used to illustrate the technical solutions of the present application and are not limiting. Although the present application has been described in detail with reference to the preferred embodiments, those of ordinary skill in the art should understand that the technical solutions of the present application can be modified. Modifications or equivalent substitutions may be made without departing from the spirit and scope of the technical solution of the present application.

What is claimed is:

1. A vehicle parking method applied to a computer device, comprising:
obtaining sensing data in an area of a parking lot using sensing devices;
generating a real-time area map of the area of the parking lot based on the sensing data, the real-time area map dynamically storing area object data and object status data corresponding to the area object data in the area of the parking lot;
in response that a parking instruction of the target vehicle is received and the target vehicle enters the area of the parking lot, determining a vehicle location of a target vehicle on the real-time area map and determining a parking space location corresponding to a target parking space in the area of the parking lot on the real-time area map based on the area object data and the corresponding object status data;
generating a parking route of the target vehicle based on the vehicle location, the parking space location and the real-time area map; and
generating a first control instruction based on the parking route, sending the parking route and the first control instruction to the target vehicle, and controlling the target vehicle to drive to the target parking space according to the parking route.

2. The vehicle parking method according to claim 1, wherein determining the parking space location corresponding to the target parking space in the area of the parking lot on the real-time area map comprises:
determining parking space status data of all parking spaces in the area of the parking lot based on the area object data and the corresponding object status data;
determining a usage status of each of all parking spaces based on the parking space status data;
determining all idle parking spaces in the area of the parking lot based on the usage status of each parking space;
determining the target parking space from all idle parking spaces according to a preset strategy; and
determining the parking space location corresponding to the target parking space on the real-time area map based on the parking space status data.

3. The vehicle parking method according to claim 1, wherein generating the real-time area map of the area of the parking lot based on the sensing data comprises:
obtaining preprocessed sensing data by preprocessing the sensing data; and
generating the real-time area map by analyzing the preprocessed sensing data using a preset map construction model.

4. The vehicle parking method according to claim 3, wherein before generating the real-time area map by analyzing the preprocessed sensing data using the preset map construction model, further comprises:
obtaining a training sample set, which comprises multiple sets of data samples collected by different sensing devices; and
obtaining the preset map construction model by training an initial map construction model using the training sample set.

5. The vehicle parking method according to claim 1, wherein generating the parking route of the target vehicle based on the vehicle location, the parking space location and the real-time area map comprises:
outputting the parking route of the target vehicle using a preset route planning model based on the vehicle location, the parking space location and the real-time area map.

6. The vehicle parking method according to claim 5, wherein before outputting the parking route of the target vehicle using the preset route planning model based on the vehicle location, the parking space location and the real-time area map, the vehicle parking method further comprises:
obtaining model training samples, which comprise multiple sets of data, each set of data of the multiple sets of data comprising an initial location of a vehicle, a destination location of the vehicle, and a real-time regional map, the multiple sets of data being different from each other; and
obtaining the preset route planning model by training an initial route planning model using the model training samples.

7. The vehicle parking method according to claim 1, further comprises:
in response that the target parking space is determined to be changed based on the area object data and the corresponding object status data, obtaining an updated parking space location corresponding to an updated target parking space and obtaining a current location of the target vehicle; and
regenerating the parking route of the target vehicle based on the current location, the updated parking space location and the real-time area map.

8. The vehicle parking method according to claim 1, wherein after controlling the target vehicle to drive to the target parking space according to the parking route, the vehicle parking method further comprises:
updating the area object data and the corresponding object status data in the area of the parking lot based on a corresponding relationship between the target vehicle and the target parking space.

9. A vehicle finding method applied to a computer device, comprising:
obtaining a real-time area map of an area of a parking lot and obtaining area object data and object status data corresponding to the area object data dynamically stored in the real-time area map in response a finding instruction of a driver for the target vehicle;
determining a parking space location corresponding to a target parking space of the target vehicle and a preset vehicle pickup location, based on the finding instruction, the area object data and the corresponding object status data;
generating a finding route of the target vehicle based on the parking space location, the preset vehicle pickup location and the real-time area map; and
generating a second control instruction based on the finding route, sending the finding route and the second control instruction to the target vehicle, and controlling the target vehicle to drive to the preset vehicle pickup location according to the finding route.

10. The vehicle finding method according to claim 9, wherein determining the parking space location corresponding to the target parking space of the target vehicle and the preset vehicle pickup location, based on the finding instruction, the area object data and the corresponding object status data, comprises:
parsing the finding instruction and obtaining a preset actual vehicle pickup location, which is located in the area of the parking lot;
determining the preset vehicle pickup location corresponding to the preset actual vehicle pickup location on the real-time area map based on the area object data and the corresponding object status data;
determining the target vehicle and a status of the target vehicle according to the area object data and the corresponding object status data; and
determining the target parking space of the target vehicle, and the parking space location corresponding to the target parking space on the real-time area map based on the target vehicle and the status of the target vehicle.

11. A computer device, comprising:
a storage device storing at least one instruction; and
at least one processor, when the at least one instruction is executed by the at least one processor, the at least one processor is caused to:
obtain sensing data in an area of a parking lot using sensing devices;
generate a real-time area map of the area of the parking lot based on the sensing data, the real-time area map dynamically storing area object data and object status data corresponding to the area object data in the area of the parking lot;
determine a vehicle location of a target vehicle on the real-time area map and determining a parking space location corresponding to a target parking space in the area of the parking lot on the real-time area map based on the area object data and the corresponding object status data, in response that a parking instruction of the target vehicle is received and the target vehicle enters the area of the parking lot;
generate a parking route of the target vehicle based on the vehicle location, the parking space location and the real-time area map; and
generate a first control instruction based on the parking route, send the parking route and the first control instruction to the target vehicle, and control the target vehicle to drive to the target parking space according to the parking route.

12. The computer device according to claim 11, wherein the at least one processor determine the parking space location corresponding to the target parking space in the area of the parking lot on the real-time area map by:
determining parking space status data of all parking spaces in the area of the parking lot based on the area object data and the corresponding object status data;
determining a usage status of each of all parking spaces based on the parking space status data;
determining all idle parking spaces in the area of the parking lot based on the usage status of each parking space;
determining the target parking space from the all idle parking spaces according to a preset strategy; and
determining the parking space location corresponding to the target parking space on the real-time area map based on the parking space status data.

13. The computer device according to claim 10, wherein the at least one processor generates the real-time area map of the area of the parking lot based on the sensing data by:
obtaining preprocessed sensing data by preprocessing the sensing data; and
generating the real-time area map by analyzing the preprocessed sensing data using a preset map construction model.

14. The computer device according to claim 13, wherein before generating the real-time area map by analyzing the preprocessed sensing data using the preset map construction model, the at least one processor is further caused to:
obtain a training sample set, which comprises multiple sets of data samples collected by different sensing devices; and
obtain the preset map construction model by training an initial map construction model using the training sample set.

15. The computer device according to claim 11, wherein the at least one processor generates the parking route of the target vehicle based on the vehicle location, the parking space location and the real-time area map by:
outputting the parking route of the target vehicle using a preset route planning model based on the vehicle location, the parking space location and the real-time area map.

16. The computer device according to claim 15, wherein before outputting the parking route of the target vehicle using the preset route planning model based on the vehicle location, the parking space location and the real-time area map, the at least one processor is further caused to:
obtain model training samples, which comprise multiple sets of data, each set of data of the multiple sets of data comprising an initial location of a vehicle, a destination location of the vehicle, and a real-time regional map, the multiple sets of data being different from each other; and
obtain the preset route planning model by training an initial route planning model using the model training samples.

17. The computer device according to claim 11, wherein the at least one processor is further caused to:
in response that the target parking space is determined to be changed based on the area object data and the corresponding object status data, obtain an updated parking space location corresponding to an updated target parking space and obtain a current location of the target vehicle; and
regenerate the parking route of the target vehicle based on the current location, the updated parking space location and the real-time area map.

18. The computer device according to claim 11, wherein after controlling the target vehicle to drive to the target parking space according to the parking route, the at least one processor is further caused to:
update the area object data and the corresponding object status data in the area of the parking lot based on a corresponding relationship between the target vehicle and the target parking space.
